(19) United States
(12) Patent Application Publication
(10) Pub. No.: US 2010/0264737 A1
(43) Pub. Date: Oct. 21, 2010

(54) THERMAL CONTROL FOR AN ENCASED POWER SUPPLY IN AN LED LIGHTING MODULE

(75) Inventors: Lance Chandler, Toutle, WA (US); Jim Scalf, Salem, OR (US); Thomas L. Downer, Ocean Park, WA (US); Laurence G. Teeter, JR., Clarksville, TN (US); Thomas T. Teeter, Guthrie, KY (US)

Correspondence Address: Schwabe Williamson & Wyatt;PACWEST CENTER, SUITE 1900, 1211 SW FIFTH AVENUE, PORTLAND, OR, 97204, US

(73) Assignee: Innovative Engineering & Product Development, Inc., Toutle, WA (US)

(21) Appl. No.: 12/427,695

(22) Filed: Apr. 21, 2009

(51) Int. Cl. H02J 7/00

(52) U.S. Cl. 307/66; 320/150

(57) ABSTRACT

Embodiments of the present disclosure provide methods, systems, and apparatuses related to managing a rechargeable battery in an enclosed lighting module. Other embodiments may be described and claimed.

### FIELD

Embodiments of the present disclosure relate to the field of lighting, and more particularly, to thermal control for an encased power supply in an LED lighting module.

### BACKGROUND

Multi-chemistry rechargeable batteries are used in a variety of applications. Often the lifetimes of these batteries could include a large number of charge/discharge cycles. However, the conditions in which these batteries are deployed and the way in which they are managed could result in a large variability of battery lifetimes.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIGS. 1a and 1b respectively illustrate exploded and assembled views of a lighting module in accordance with embodiments of this disclosure.

FIG. 2 illustrates a circuit diagram of components of a lighting module in accordance with some embodiments.

FIG. 3 is a flowchart describing controlling operations in accordance with some embodiments.

### DETAILED DESCRIPTION

In the following detailed description, reference is made to the accompanying drawings which form a part hereof wherein like numerals designate like parts throughout, and in which is shown by way of illustration embodiments in which the disclosure may be practiced. It is to be understood that other embodiments may be utilized and structural or logical changes may be made without departing from the scope of the present disclosure. Therefore, the following detailed description is not to be taken in a limiting sense, and the scope of embodiments in accordance with the present disclosure is defined by the appended claims and their equivalents.

Various operations may be described as multiple discrete operations in turn, in a manner that may be helpful in understanding embodiments of the present disclosure; however, the order of description should not be construed to imply that these operations are order dependent.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

Various components may be introduced and described in terms of an operation provided by the components. These components may include hardware, software, and/or firmware elements in order to provide the described operations. While some of these components may be shown with a level of specificity, e.g., providing discrete elements in a set arrangement, other embodiments may employ various modifications of elements/arrangements in order to provide the associated operations within the constraints/objectives of a particular embodiment.

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

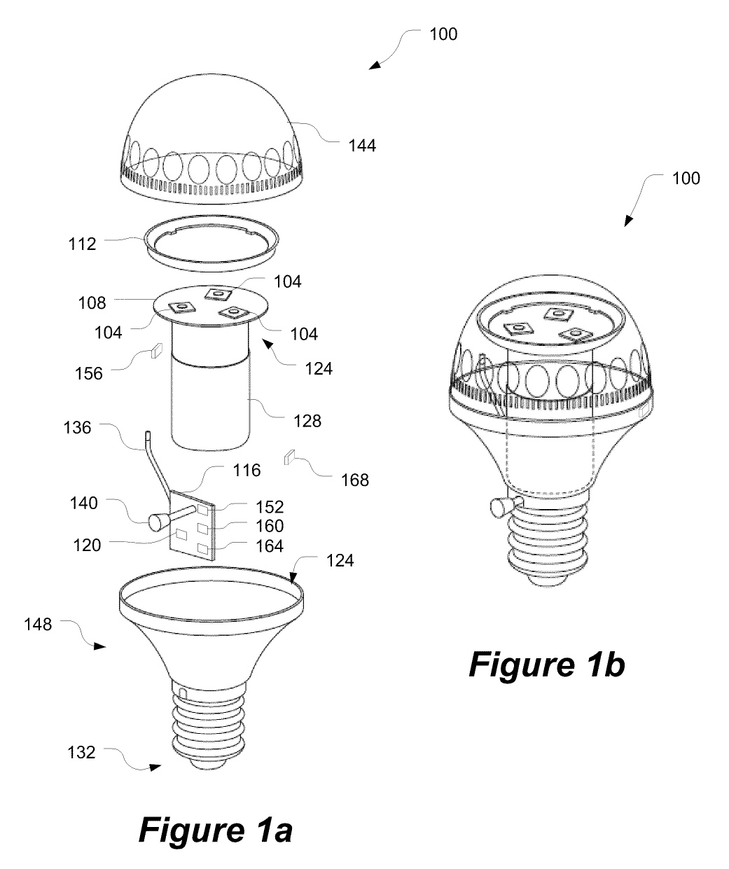

FIGS. 1a and 1b illustrate a lighting module 100 in an exploded view and an assembled view, respectively, in accordance with some embodiments. The lighting module 100 may include one or more light emitting diodes (LEDs) 104 coupled to a mounting board 108 that provides power connections to the LEDs 104. While three LEDs 104 are shown, other embodiments may have any number of LEDs. A lens reflector 112 may be placed around a perimeter of the mounting board 108 to provide a desired optical effect.

The lighting module 100 may also include a circuit board 116 that may house and interconnect various electrical components of the lighting module 100 including, but not limited to, a controller 120. The controller 120 may be coupled to a direct current (DC) power supply interface 124 that is configured to be coupled to a rechargeable battery 128 (hereinafter “battery 128”), which may be a multi-chemistry rechargeable battery. In some embodiments, the battery 128 may be removably coupled to the DC power supply interface 124 in order to be easily replaced at the end of its effective life. In other embodiments, the battery 128 may be permanently coupled to the DC power supply interface 124. In these embodiments, the entire lighting module 100 may be replaced, rather than just the battery 128, at the end of the effective life of the battery 128.

As used herein, “removably coupled elements” are elements in which the coupling design allows a user of the device to couple/decouple the elements in the ordinary course of operation; while “permanently coupled elements” are elements in which the coupling design does not allow the user of the device to couple/decouple the elements in the ordinary course of operation.

The controller 120 may also be coupled to an alternating current (AC) power supply interface 132 that is configured to be coupled to an AC power supply through, e.g., a standard lighting fixture. The AC power supply interface 132 may be an Edison screw base, of any size, as is generally shown. In other embodiments, the AC power supply interface 132 may be any other type of light bulb connector or power connector, e.g., power plug.

When power is present at the AC power supply interface 132, the controller 120 may use the AC power to power the LEDs 104 and to recharge the battery 128, as will be described in more detail below. When AC power is not present at the AC power supply interface 132, the controller 120 may use the DC power from the battery 128 to power the LEDs 104. Providing backup power from the battery 128 may allow the lighting module 100 to work independent of an available AC power system. This may allow the lighting module 100 to provide a portable and/or auxiliary light source (e.g., a light source to be used when a power outage occurs in a building's electrical network).

When operating as an auxiliary light source, the lighting module 100 may detect AC power in an electrical network to which it is communicatively coupled. The lighting module 100 may be communicatively coupled to the electrical network by a direct electrical connection, e.g., by a lighting fixture plugged into an outlet, or wirelessly. The lighting module 100 may include an antenna 136 and a resonant circuit in an embodiment in which it is configured to wirelessly detect AC power in a proximally-disposed electrical network as is described in co-pending application titled LIGHTING MODULE WITH WIRELESS ALTERNATING CURRENT DETECTION SYSTEM filed on Mar. 31, 2009, assigned Ser. No. 12/415,888. The specification of said application is hereby incorporated in its entirety except for those sections, if any, that are inconsistent with the present specification.

The lighting module 100 may also include a state switch 140 coupled to the controller 120 through the circuit board 116. The state switch 140 may be operated to change between various operating states of the lighting module 100. For example, in one embodiment the lighting module 100 may have two states. In a first state, the lighting module 100 may function as an auxiliary light. That is, the LEDs 104 are activated when AC power is not detected in an electrical network to which the lighting module 100 is communicatively coupled. In a second state, the LEDs 104 may be activated, regardless of the presence/absence of AC power in the electrical network. In other embodiments, additional and/or alternative states may be provided.

The components of the lighting module 100, including the battery 128 when it is coupled to the DC power supply interface 124, may be disposed within an enclosure defined, at least in part, by a bulb-shaped, light passable body 144 (hereinafter “body 144”) and a base 148, which may include the AC power supply interface 132. The lighting module 100 may include a temperature sensing device 152 that is coupled to the controller 120 and thermally coupled to the battery 128. The temperature sensing device 152 may be thermally coupled to the battery 128 by being proximately disposed with the battery 128 such that an output of the temperature sensing device 152 is proportional to a temperature of the battery 128.

The temperature sensing device 152 is shown as being disposed on the circuit board 116; however, in other embodiments it may be disposed in other locations within the enclosure. Furthermore, in other embodiments, additional temperature sensing devices may be placed throughout the enclosure. For example, one temperature sensing device may be placed near the battery 128 while another temperature sensing device may be placed near the LEDs 104.

Disposing the components of the lighting module 100 within the enclosure, as shown, facilitates use of the lighting module 100 as an interchangeable replacement for conventional light bulbs. However, the confinements of the enclosure may restrict heat dissipation and compromise the utility and/or longevity of the battery 128. For example, if the battery 128 is exposed to excessively high temperatures, a separator, separating an anode and a cathode, may break down and damage the battery 128 and/or the lighting module 100. Recharging the battery 128 and powering the LEDs 104, if not properly managed, may accelerate the separator breakdown.

While excessively high temperatures could compromise the performance of elements of the lighting module 100 so, too, could excessively low temperatures. In some embodiments, it may be that when the temperature of the battery 128 is below a threshold temperature the power provided by the battery 128 may be backed off a certain amount from a rated power to avoid damage to the battery 128. The amount of the back-off may be determined by a derating curve associated with the battery 128.

In some embodiments, the lighting module 100 may include a heating element 156 that may be used to increase a temperature associated with the battery 128 when it is determined that the temperature is excessively low. This may also work to reduce humidity within the enclosure that, uncontrolled, may adversely effect the LEDs 104.

Accordingly, embodiments of the disclosure described herein present various management techniques and/or analyses that the controller 120 may employ to increase the useful life of the battery 128 and/or lighting module 100.

The controller 120 may be coupled with memory 160, which may be volatile and/or non-volatile memory that stores data that may relate to the operation of the battery 128. The data may include impedance, temperature, current, electric reflectivity, number of cycles, and total coulomb-metric data for the life of the battery 128, etc. The controller 120 may acquire this data from a programming device through a programming interface 164, from one or more sensors of the lighting module 100, e.g., the temperature sensing device 152, and/or from monitoring/testing the operation of the battery 128 itself. The controller 120 may use this data as a basis for managing the lighting module 100 including, e.g., controlling the recharging cycles of the battery 128 and/or controlling the powering of the LEDs 104.

The controller 120 may control an indicator LED 168 in a manner to communicate information that may correspond to the battery 128. For example, the indicator LED 164 may indicate that a temperature associated with the battery 128 is outside of a predetermined operating range, e.g., it is either above an upper predetermined threshold temperature or below a lower predetermined threshold temperature. In other embodiments, other indication methods, which may include more than one indicator LED, may be employed.

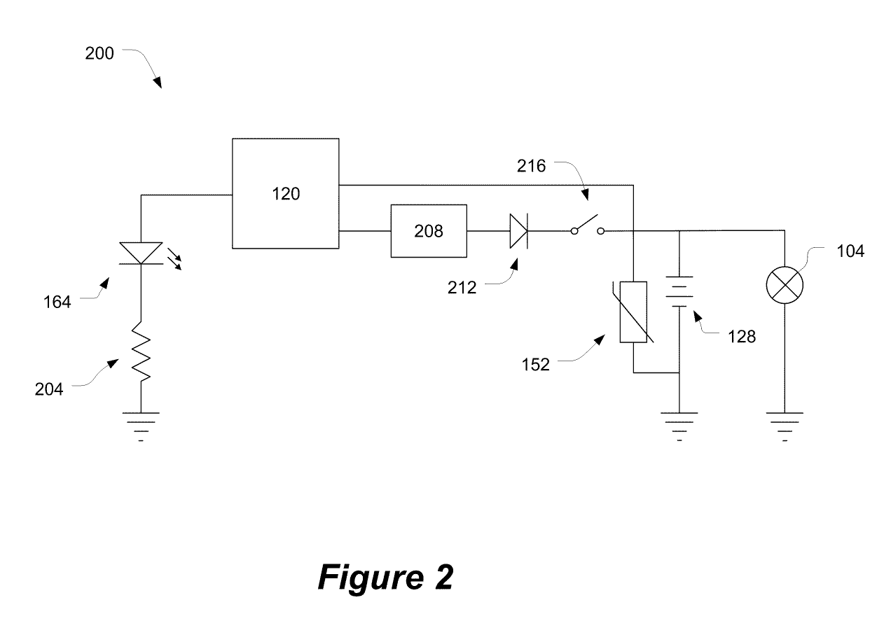

FIG. 2 is a circuit diagram 200 of elements of the lighting module 100 in accordance with some embodiments. The circuit diagram 200 includes the controller 120, the LEDs 104, the battery 128, the temperature sensing device 152, and the indicator LED 164, previously introduced. The circuit diagram 200 may also include a resistor 204, a converter 208, a diode 212, and a switch 216 coupled to one another and the early elements at least as shown.

Briefly, the converter 208 may be a DC-DC converter and/or an AC-DC converter used to provide a desired charging current to the battery 128 and/or a desired powering current to the LEDs 104. The converter 208 may be set for a constant voltage or a constant current operation. The converter 208 may be coupled to the battery 128 and LEDs 104 through the diode 212, which may function as a forward biasing diode, and the switch 216.

The controller 120 may receive thermal feedback from the temperature sensing device 152. The temperature sensing device 152 may be a thermistor, as is generally shown, that has a negative temperature coefficient causing the resistance to decrease in response to a corresponding increase in temperature. The controller 120 may control the switch 216, which may include one or more switching elements distributed throughout the circuit, to control operation of the elements of the lighting module 100 based at least in part on the thermal feedback provided by the temperature sensing device 152.

The resistor 204 may be used to set the desired voltage for the indicator LED 164.

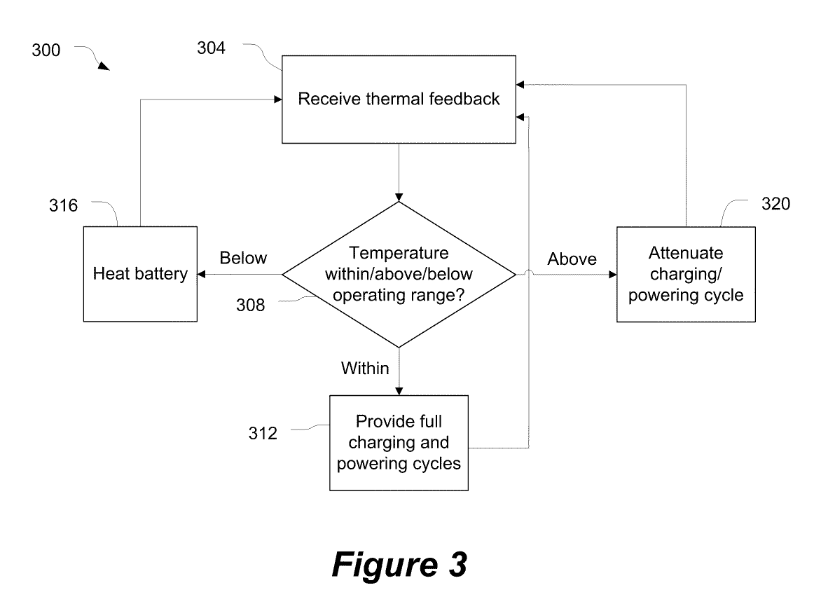

FIG. 3 is a flowchart 300 showing controlling operations of the controller 120 in accordance with some embodiments.

At block 304, the controller 120 may receive thermal feedback from the temperature sensing device 152. The thermal feedback may be an output, e.g., a resistance measurement, that is proportional to a temperature of the battery 128.

At block 308, the controller 120 may determine whether the temperature of the battery 128 is within, above, or below an operating range. The operating range may be defined, e.g., by an upper predetermined threshold temperature value and a lower predetermined threshold value. In various embodiments, any number of intermediary threshold values may be used to define any number of operating ranges.

If the controller determines that the temperature is within the operating range, it may, at block 312, provide full charging and powering cycles. A full charging cycle may mean that the controller 120 may recharge the battery 128 at a recharge rate that is not constrained by operating temperature considerations. It may be noted that the recharge rate during a full charging cycle may be a variety of rates, e.g., a float-charging rate that takes 300 hours to recharge a full capacity of the battery 128 or a boost-charge rate that takes 2 hours to recharge the full capacity of the battery 128.

Similar to a full charging cycle, a full powering cycle may mean that the controller 120 may power the LEDs 104 at a powering rate that is not constrained by considerations of the operating temperature of the battery 128.

In the event the controller 120 determines the temperature is below the operating range, the controller 120 may, at block 316, control the heating element in a manner to heat the battery 128. The controller 120 may then again receive thermal feedback at block 304. In various embodiments, the controller 120 may power the LEDs 104 from the battery 128 according to an attenuated powering cycle that corresponds to the derating curve when the temperature is below the operating range. An attenuated powering cycle may mean that the controller 120 may power the LEDs 104 at a reduced powering rate due to considerations of the operating temperature of the battery 128.

If the controller 120 determines the temperature is above the operating range, it may, at block 320, recharge the battery 128 with an attenuated recharging cycle and/or power the LEDs 104, from the AC power supply or the battery 128, with an attenuated powering cycle. Similar to an attenuated powering cycle, an attenuated charging cycle of the battery 128 may mean that the controller 120 may recharge the battery 128 at a reduced recharge rate due to considerations of the operating temperature of the battery 128. In some embodiments, the controller 120 may recharge the battery 128 according to an attenuated recharging cycle while powering the LEDs 104 from the AC power supply with a full powering cycle.

Managing the recharging, heating, and powering of the components of the lighting module 100 as described may increase in the operational life of the lighting module 100.

Although certain embodiments have been illustrated and described herein for purposes of description of the preferred embodiment, it will be appreciated by those of ordinary skill in the art that a wide variety of alternate and/or equivalent embodiments or implementations calculated to achieve the same purposes may be substituted for the embodiments shown and described without departing from the scope of the present disclosure. Similarly, memory devices of the present disclosure may be employed in host devices having other architectures. This application is intended to cover any adaptations or variations of the embodiments discussed herein. Therefore, it is manifestly intended that embodiments in accordance with the present disclosure be limited only by the claims and the equivalents thereof.

What is claimed is:

1. An apparatus comprising:
a bulb-shaped light-passable body to define, at least in part, an enclosure;
a light emitting diode (LED) disposed within the enclosure;
a first power supply interface configured to be coupled to a rechargeable battery in a manner such that the rechargeable battery, when so coupled, is disposed within the enclosure;
a second power supply interface configured to be coupled to an alternating current (AC) power supply;
a temperature sensing device configured to be thermally coupled to the rechargeable battery to provide an output proportional to a temperature of the rechargeable battery; and
a controller disposed within the enclosure and coupled to the LED, the first power supply interface, the second power supply interface, and the temperature sensing device and configured to
recharge the rechargeable battery from the AC power supply through the second power supply interface;
power the LED from the rechargeable battery through the first power supply interface or the AC power supply through the second power supply interface; wherein the controller is further configured to recharge the rechargeable battery and/or power the LED based at least in part on the output of the temperature sensing device.

2. The apparatus of claim 1, wherein the controller is further configured to
determine the temperature is greater than a predetermined threshold temperature based at least in part on the output, and
recharge the rechargeable battery with an attenuated charging cycle based at least in part on the determination that the temperature is greater than the predetermined threshold temperature.

3. The apparatus of claim 2, wherein the controller is further configured to
power the LED with a full power cycle through the attenuated charging cycle.

4. The apparatus of claim 1, wherein the controller is further configured to
determine the temperature is greater than a predetermined threshold temperature based at least in part on the output, and
power the LED with an attenuated powering cycle based at least in part on the determination that the temperature of the rechargeable battery is greater than the predetermined threshold temperature.

5. The apparatus of claim 1, further comprising
an Edison screw base to provide the second power supply interface.

6. The apparatus of claim 1, further comprising:
another LED; and
the controller is further configured to activate the another LED based at least in part on the output of the temperature sensing device.

7. The apparatus of claim 1, further comprising:
the rechargeable battery permanently coupled to the first power supply interface.

8. The apparatus of claim 1, further comprising:
a heating element; and
the controller is further configured to determine the temperature is below a predetermined threshold temperature based at least in part on the output, and to control the heating element to heat the rechargeable battery based at least in part on said determination that the temperature is below the predetermined threshold temperature.

9. A method comprising:
receiving, by a controller from a temperature sensing device, an output proportional to a temperature of a rechargeable battery disposed within an enclosure defined at least in part by a bulb-shaped light passable body;
recharging, by the controller, the rechargeable battery from an alternating current (AC) power supply; and
powering, by the controller, a light emitting diode (LED) disposed within the enclosure from the rechargeable battery, wherein said recharging and/or powering is based at least in part on said receiving of the output.

10. The method of claim 9, further comprising:
determining the temperature of the rechargeable battery is greater than a predetermined threshold temperature, and
recharging the rechargeable battery with an attenuated charging cycle based at least in part on said determining that the temperature of the rechargeable battery is greater than the predetermined threshold temperature.

11. The method of claim 9, further comprising:
powering the LED with a full powering cycle through the attenuated charging cycle.

12. The method of claim 9, further comprising:
determining the temperature of the rechargeable battery is greater than a predetermined threshold temperature, and
powering the LED with an attenuated powering cycle based at least in part on said determining that the temperature of the rechargeable battery is greater than the predetermined threshold temperature.

13. The method of claim 9, further comprising:
activating another LED based at least in part on the output of the temperature sensing device.

14. The method of claim 9, further comprising:
determining the temperature of the rechargeable battery is below a predetermined threshold temperature; and
heating the rechargeable battery based at least in part on said determining the temperature is below the predetermined threshold temperature.
